(19) United States
(12) Patent Application Publication
(10) Pub. No.: US 2005/0184966 A1
(43) Pub. Date: Aug. 25, 2005

(54) Method and device for specifying pointer position, and computer product

(75) Inventor: Yutaka Katsuyama, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: Fujitsu Limited

(21) Appl. No.: 10/879,802

(22) Filed: Jun. 29, 2004

(30) Foreign Application Priority Data
Feb. 10, 2004 (JP) 2004-032887

(51) Int. Cl. G03B 21/00

(52) U.S. Cl. 345/173

(57) ABSTRACT

In a frame image, areas near which high-luminance pixels in red color are concentrated are regarded as pointer candidate areas. Whether a luminance distribution that is characteristic of a standing-still pointer is present radially from the center of each area is checked. If the pointer is not found, the areas are narrowed down. If the pointer is still not found, a moving pointer is detected through an in-between frame differential process and a positional relation between the specified pointer coordinates and a plurality of characters in the frame is calculated. Based on a positional relation of the characters with each corresponding character on the slide, the coordinates on the slide corresponding to the coordinates of the specified pointer are calculated.

### CROSS-REFERENCE TO RELATED APPLICATIONS

This application is based upon and claims the benefit of priority from the prior Japanese Patent Application No. 2004-032887, filed on Feb. 10, 2004, the entire contents of which are incorporated herein by reference.

### BACKGROUND OF THE INVENTION

1) Field of the Invention

The present invention relates to technology for specifying (identifying) coordinates of a pointer on a slide based on an image of the slide and the pointer on the slide.

2) Description of the Related Art

Nowadays various types of distant learning techniques that use the Internet or the like, i.e., so-called “E-learning”, are available. Typically, moving images obtained by shooting a lecture given by a lecturer, and enlarged images of slides projected by an overhead projector (OHP) and shot in each frame, are synchronized with each other for playback and display on screens of the terminals of the students. This makes it possible to solve the conventional problem that it is difficult to understand where on the screen the lecturer is pointing at on the slide or it is difficult to read the contents of the slides. This method makes it possible to realize the environment that is almost identical to that in the actual lecture.

However, in the above conventional technology, the slide shown in each frame of the moving image has to be manually specified. The inventors of the present invention have developed a technology of automatically associating each frame in the moving images with each slide (refer to, for example, Japanese Patent Laid-Open Publication No. 2003-281542 and Japanese Patent Laid-Open Publication No. 2003-288597). This technology makes it possible to significantly reduce time and trouble conventionally required for the above operation.

The conventional technology merely makes it possible to specify a slide on which attention is focused in the moving image. In an actual lecture, the lecturer often describes details of a single slide in sequence. That is, the point of attention sequentially moves even in a single slide. However, the conventional technology does not allow the point the lecturer is describing in a slide to be clearly demonstrated.

Also, it is possible to manually create contents by specifying an attention point on a slide while listening to a lecturer to cause the specified point to be highlighted for display. This operation, however, requires an operation time several times more than a time required for playback of moving images as well as a high degree of concentration, thereby enormously increasing cost required for developing the contents.

Other than the above, patent documents related to automatic detection of a laser pointer include, for example, Japanese Patent Laid-Open Publication No. H7-261919 and Published Japanese Translation of PCT Application No. H11-509660. Patent documents related to calibration include, for example, Japanese Patent Laid-Open Publication No. 2001-235819.

Furthermore, the following literature discloses the conventional technology:
1) R. Sukthankar, R. G. Stockton, M. D. Mullin, “Self-Calibrating Camera-Assisted Presentation Interface”, U.S.A., International Conference on Control, Automation, Robotics and Vision ICARCV, 2000
2) C. Kirstein, H. Muller, “Interaction with a Projection Screen Using a Camera-Tracked Laser Pointer”, Proceedings of The International Conference on Multimedia Modeling (MMM '98), IEEE, Computer Society Press, 1988
3) Evegeny Poopvich, “PresenterMouse LASER-Pointer Tracking System”
4) Dan R. Olsen Jr., T. Nielsen, “Laser Pointer Interaction”, CHI, Conference on Human Factors in Computing Systems, 2001
5) F. Liu, X. Lin, Y. Shi, “Interaction with a Projection Screen Using Laser Pointer”, (China).

In the conventional technology, various schemes can be used for specifying a position of the laser pointer. However, most schemes require an optical device, a special filter, a light source, and the like. A normal projector, a camera, and a laser pointer are not enough to achieve the conventional technology. Other exemplary schemes include a scheme of using a high-luminance laser pointer, a scheme of detecting a pointer by its color or shape or a frame difference, and a combination of these schemes as appropriate. Similarly, in a scheme of calculating coordinates on the slide corresponding to the pointer position, a specific device or environment is often required and, if not required, calibration has to be performed in advance.

### SUMMARY OF THE INVENTION

It is an object of the present invention to solve at least the problems in the conventional technology.

A computer program according to an aspect of the present invention is a computer program for specifying pointer position by identifying coordinates of a pointer on a slide based on an image of the slide and an image of the pointer on the slide. The computer program causes a computer to execute generating a differential image between a first image and a second image; generating two different binary images from the differential image; identifying areas in which the pointer is possibly located in each of the binary images; and specifying, when each of the binary images includes one area obtained by unifying the areas identified and a distance between the areas included in the binary images is shorter than a threshold, coordinates of a point on the slide corresponding to either one of center points of the areas included in the binary images.

A computer program according to another aspect of the present invention is a computer program for specifying pointer position by identifying coordinates of a pointer on a slide based on an image of the slide and an image of the pointer on the slide. The computer program causes a computer to execute identifying areas in which the pointer is possibly located in the images; determining whether a luminance distribution characteristic of the pointer that stands still is present within a predetermined range from a center point of any one of the areas identified; and specifying, when it is determined at the determining that the luminance distribution is present within the predetermined range, coordinates of a point on the slide corresponding to the center point.

A computer program according to still another aspect of the present invention is a computer program for specifying pointer position by identifying coordinates of a pointer on a slide based on an image of the slide and an image of the pointer on the slide. The computer program causes a computer to execute identifying areas in which the pointer is possibly located in the image; identifying areas of a specific color in the shot image; narrowing down the areas identified to areas in which the pointer is possibly located based on a positional relation with the area identified; and specifying coordinates of a point on the slide corresponding to a center point of a largest one of areas obtained by unifying the areas narrowed down.

A method according to still another aspect of the present invention is a method of specifying pointer position by identifying coordinates of a pointer on a slide based on an image of the slide and an image of the pointer on the slide. The method includes generating a differential image between a first image and a second image; generating two different binary images from the differential image; identifying areas in which the pointer is possibly located in each of the binary images; and specifying, when each of the binary images includes one area obtained by unifying the areas identified and a distance between the areas included in the binary images is shorter than a threshold, coordinates of a point on the slide corresponding to either one of center points of the areas included in the binary images.

A device according to still another aspect of the present invention is a device for specifying pointer position by identifying coordinates of a pointer on a slide based on an image of the slide and an image of the pointer on the slide. The device includes a differential image generating unit that generates a differential image between a first image and a second image; a binary image generating unit that generates two different binary images from the differential image; an area identifying unit that identifies areas in which the pointer is possibly located in each of the binary images; and a pointer position specifying unit that specifies, when each of the binary images includes one area obtained by unifying the areas identified and a distance between the areas included in the binary images is shorter than a threshold, coordinates of a point on the slide corresponding to either one of center points of the areas included in the binary images.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is for explaining an example of a hardware structure of a pointer position specifying device according to a first embodiment of the present invention;

FIG. 2 is a functional block diagram of the pointer position specifying device according to the first embodiment;

FIG. 3 is a flowchart of a pointer position specifying process performed by the pointer position specifying device shown in FIG. 3;

FIG. 4 is a schematic diagram for explaining a pointer red color definition held in a pointer candidate area specifying unit 201 shown in FIG. 3;

FIG. 5 is a flowchart of the procedure of generating a pointer red color definition;

FIG. 6 is a flowchart of a pointer candidate area specifying process performed by the pointer candidate area specifying unit 201 (step S302 of FIG. 3);

FIG. 7 is a diagram for explaining one example of a binary image generated at step S602 of FIG. 6;

FIG. 8 is a diagram for explaining one example of a count image generated at step S603 of FIG. 6;

FIG. 9 is a graph for explaining a standard distribution of pixel luminance (still pointer characteristic) near a standing-still laser pointer;

FIG. 10 is a flowchart of a still pointer specifying process (step S303 of FIG. 3) performed by a still pointer specifying unit 202 shown in FIG. 3;

FIG. 11 is a diagram for explaining a specific example of search directions of the still pointer characteristic;

FIG. 12 is a flowchart of a process of narrowing down pointer candidate areas (step S305 of FIG. 3) performed by a pointer candidate area narrowing down unit 203 shown in FIG. 3;

FIG. 13 is a flowchart of a moving pointer specifying process (step S307 of FIG. 3) performed by a moving pointer specifying unit 204 shown in FIG. 3;

FIG. 14 is a diagram for explaining a state in which a distance between pointer candidate areas is determined at step S1311 of FIG. 13;

FIG. 15 is a diagram for explaining a state in which a pointer position is specified at step S309 of FIG. 13;

FIG. 16 is a flowchart of an identification information generating process performed by an identification information generating unit 207 shown in FIG. 3;

FIG. 17 is a diagram for explaining a specific example of the case where characters do not have a one-to-one correspondence;

FIG. 18 is a schematic flowchart of a pointer position specifying process performed by a pointer position specifying device according to a second embodiment of the present invention;

FIG. 19 is a flowchart of a moving pointer specifying process (step S1803 of FIG. 18) performed by a moving pointer specifying unit 204 according to the second embodiment;

FIG. 20 is a flowchart of a process of associating characters with each other through projective transformation; and

FIG. 21 is a schematic diagram of the principle of projective transformation.

### DETAILED DESCRIPTION

Exemplary embodiments of a method, a device, and a computer product for specifying pointer position according to the present invention are described in detail below while referring to the accompanying drawings.

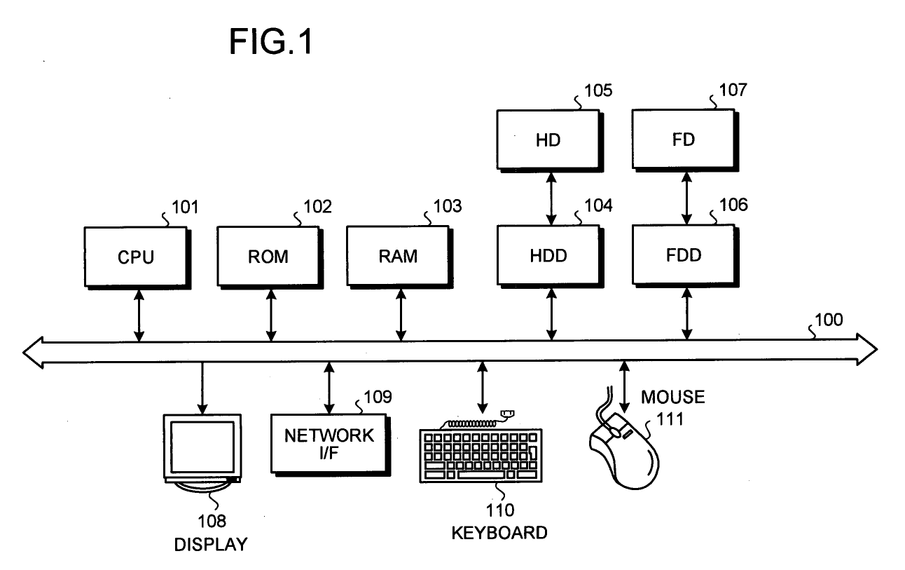

FIG. 1 illustrates a hardware structure of a pointer position specifying device on which a computer program according to a first embodiment is operated. The pointer position specifying device includes a CPU 101, a ROM 102, a RAM 103, a hard disk drive (HDD) 104, a hard disk (HD) 105, a flexible disk drive (FDD) 106, a flexible disk (FD) 107, a display 108, a network interface (I/F) 109, a keyboard 110, and a mouse 111. All these components are connected to each other via a bus 100.

The CPU 101 controls over the entire device. The ROM 102 stores a boot programs and other programs. The RAM 103 is used as a work area of the CPU 101.

The HDD 104 controls data read or write or both to the HD 105 according to the control of the CPU 101. The HD 105 stores data written according to the control of the HDD 104. The FDD 106 controls data read or write or both to the FD 107 according to the control of the CPU 101. The FD 107 stores data written according to the control of the FDD 106. The FD 107 is merely an example of a removable storage medium. In place of the FD 107, a CD-ROM (CD-R or CD-RW), a Magnet Optical (MO), a Digital Versatile Disk (DVD), a memory card or the like may be used.

The display 108 displays various data, such as documents and images including a cursor, a window, and an icon. The network I/F 109 is connected to a network, such as a LAN or a WAN or both, for data transmission or reception or both between the network and the inside of the device. The keyboard 110 includes a plurality of keys for input of characters, numbers, and various instructions, and inputs data corresponding to the pressed key to the inside of the device. The mouse 111 inputs the amount of rotation and the rotating direction of a ball provided on the bottom portion of its body and ON and OFF of each button provided on the upper portion of the body to the inside of the device as required.

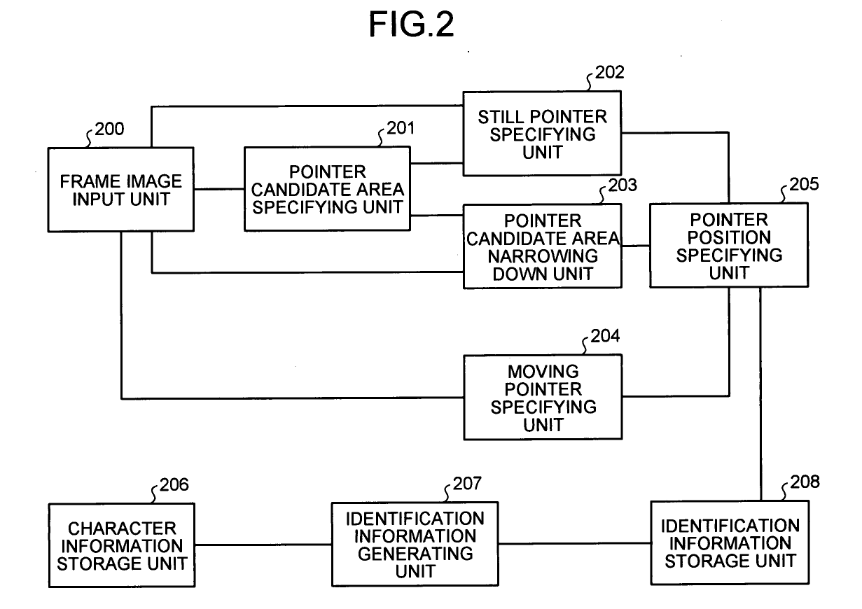

FIG. 2 illustrates a functional block diagram of the pointer position specifying device according to the first embodiment. The pointer position specifying device includes a frame image input unit 200, a pointer candidate area specifying unit 201, a still pointer specifying unit 202, a pointer candidate area narrowing down unit 203, a moving pointer specifying unit 204, a pointer position specifying unit 205, a character information storage unit 206, an identification information generating unit 207, and an identification information storage unit 208.

The character information storage unit 206 and the identification information storage unit 208 are implemented by, for example, the HD 105. Also, the other components are achieved by the computer program according to the first embodiment being read from the HD 105 or the like to the RAM 103 and then being executed by the CPU 101.

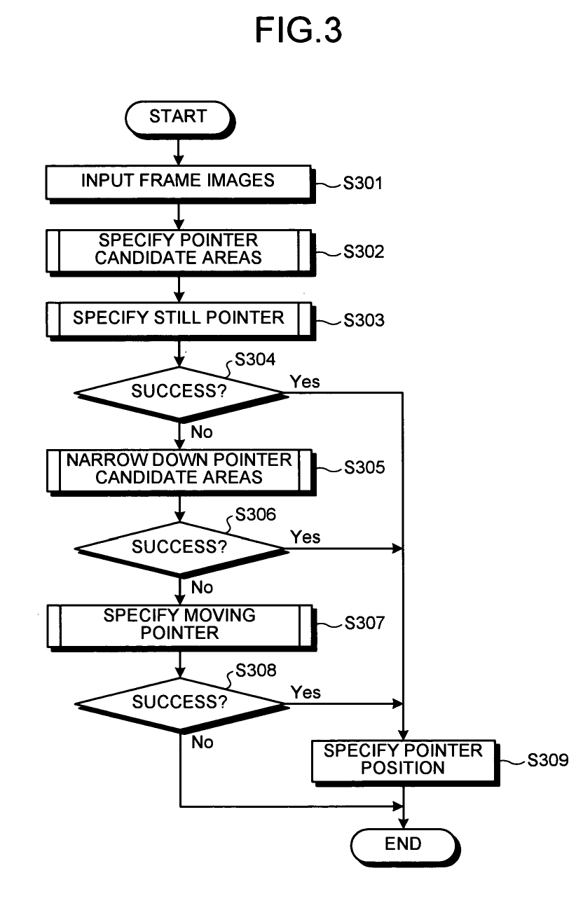

FIG. 3 is a schematic flowchart of a pointer position specifying process performed by the pointer position specifying device according to the first embodiment. The device first captures moving images (frame images) of, for example, a lecture shot by a video camera from the frame image input unit 200 (step S301). Then, the pointer candidate area specifying unit 201 specifies pointer candidate areas (areas in which the laser pointer is possibly located) in each image (step S302).

Next, the still pointer specifying unit 202 specifies an area in which a pointer completely standing still in a frame image (hereinafter, “still pointer”) is located from among the specified areas (step S303). If such a still pointer is successfully detected, the procedure goes to a process of specifying a pointer position originally on the slide performed by the pointer position specifying unit 205 (step S304: Yes, step S309).

On the other hand, if such a still pointer is not found (step S304: No), the pointer candidate narrowing down unit 203 excludes, from the pointer candidate areas specified at step S302, an area possibly considered as noise in view of a positional relation with a red pattern (step S305).

If the areas are successfully narrowed down to one area, the procedure goes to a process performed by the pointer position specifying unit 205 of specifying a pointer position originally on the slide (step S306: Yes, step S309). If no particular area is specified (step S306: No), the moving pointer specifying unit 204 compares a plurality of frame images to specify an area in which a pointer moving on the screen (hereinafter, “moving pointer”) is located (step S307).

If a moving pointer is found, the pointer position specifying unit 205 specifies a pointer position originally on the slide (step S308: Yes, step S309). That is, coordinates on the shot slide corresponding to (the center point of) the pointer area in the above-specified frame image are specified. If no moving pointer is found (step S308: No), it is decided that no pointer is present, and then the procedure ends.

Next, details on the function of each component shown in FIG. 2 and the process of each step in FIG. 3 are described in sequence. First, the frame image input unit 200 is a functional unit of capturing and storing therein a plurality of frame images shot by a camera provided outside the device, and also sequentially outputting them to the pointer candidate area specifying unit 201, the still pointer specifying unit 202, the pointer candidate area narrowing down unit 203, or the moving pointer specifying unit 204, which will be described further below.

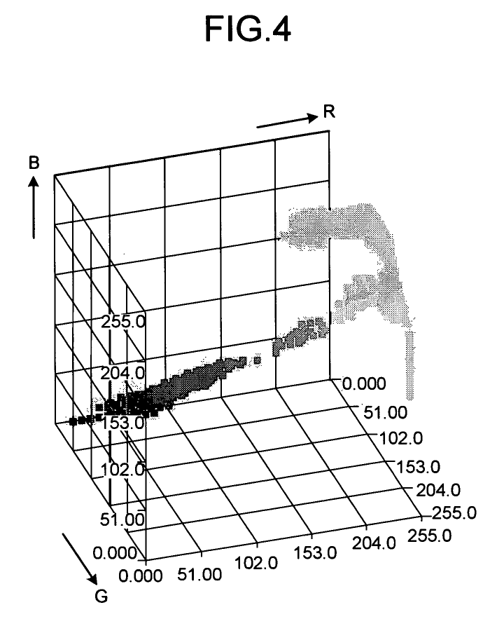

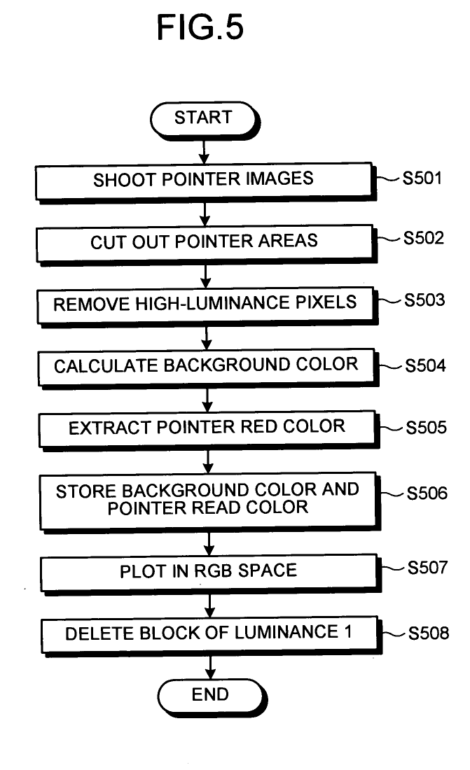

The pointer candidate area specifying unit 201 is a functional unit for specifying (coordinates of) a pointer candidate area in the frame image supplied by the frame image input unit 200. For this process, the pointer candidate area specifying unit 201 retains a pointer red color definition schematically depicted in FIG. 4. This pointer red color definition is generated through the procedure shown in FIG. 5.

First, a fixed position on a uniformly-colored background is radiated with a laser pointer, and its image is then shot by a fixed camera. Next, the background is sequentially changed to have 4,913 different colors. That is, 4,913 pointer images are shot (step S501).

Next, a rectangular area having a predetermined size with its center on the laser pointer is cut out from each shot image (step S502). Since the radiation point is fixed, the cutout process is performed by determining coordinates of four points of a rectangle and then simply cutting out the inside of the rectangle. Then, high-luminance pixels at the center of the pointer are removed (masked) from the cut-out area (step S503). Specifically, pixels satisfying, for example, R value+G value+B value>600 are to be removed.

Next, a “background color” of the area is calculated by using the remaining pixels (step S504). Also “a pointer red color” is extracted from the remaining pixels (step S505). This “background color” represents an average value of colors of the remaining pixels located at the most outer portion of the area (those located on four sides of the cutout rectangle).

The “pointer red color” is a color of the remaining pixels satisfying “R value≧210 and R value≧R value of the background color” (corresponding to red pixels appearing on the outer rim of the pointer). The “background color” and the “pointer red color” are stored in a working table so as to be associated with each other (step S506). These processes of steps S502 through S506 are repeated for all images in 4,913 colors.

Upon completion of these processes performed on all images, the pointer red color stored in the table is plotted in an RGB space depicted in FIG. 4 (step S507). At this time, each of the RGB axes is divided into 32 blocks to divide the space into 32,768 (=the cubic of 32) blocks. In each block, the frequency (number) of points is calculated. In other words, each of the R value, the G value, and the B value of the pointer red color extracted from the image is quantized into 32 levels for plotting.

Here, the color distribution obtained in the above manner may be redundant as information for detection of the still pointer. The reason is as follows. That is, the red color of the pointer is subtly varied for each pixel even in a single image. Consequently, a plurality of pointer red colors are usually extracted from a single image, and are then plotted as a plurality of points. To detect a still pointer, however, it is enough to locate at least one point in the space of a single image (in other word, a single background color).

To remove such redundancy, a block containing a less frequency of occurrence of points, specifically, a block containing only one point (block with frequency of 1), is retrieved from the 32,768 blocks, and then that point is deleted from that block (step S508). This deleting is performed so that a cover ratio defined below is smaller than a threshold: cover ratio=number of images excluding the block with frequency of 1 on which the block frequency calculation is based/total number of images.

While the cover ratio is 100%, even if one point in the block with frequency of 1 is deleted, there is always another point in another block extracted from the same image. In other words, of the plurality of pointer red colors extracted from the laser pointer on the background, even one pointer red color is disregarded, at least another one pointer red color is plotted in the space of FIG. 4. Also, since the 4,913 images are all once used, the cover ratio can be said as a use ratio of the images.

If the threshold of the cover ratio is 100% (that is, if the 4,913 images are completely used for calculating a color distribution), however, the color distribution spreads over a wide range of the RGB space. Therefore, it is experimentally known that, if this threshold is adopted for a pointer red color definition, a lot of noises will be extracted. Therefore, here, although a pointer may not be able to be reliably detected, the pointer red color distribution having a cover ratio of 98%, at which noise extraction is reduced, is adopted for the pointer red color definition. The user pointer red color definition depicted in FIG. 4 is at the cover ratio of 98%.

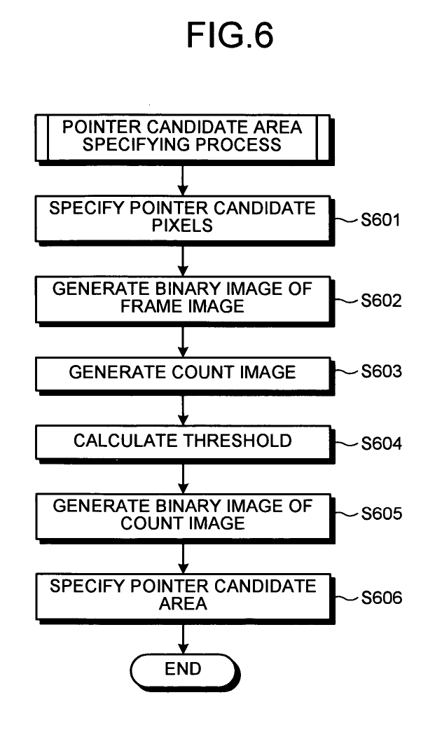

FIG. 6 is a flowchart of a pointer candidate area specifying process performed by the pointer candidate area specifying unit 201 (step S302 of FIG. 3).

First, the pointer candidate area specifying unit 201 specifies pointer candidate pixels (pixels at which the laser pointer is possibly located) in the frame images supplied by the frame image input unit 200 (step S601). Specifically, the pixels in the frame images are searched for high-luminance pixels whose R value is larger than a threshold (254, for example) and whose G value is smaller than its B value. If a pixel having a color in the pointer read color definition of FIG. 4 is present near the found pixels (for example, within two adjacent pixels), that pixel is taken as the pointer candidate pixel. Such detected pointer candidate pixels are concentrated near the correct pointer. However, many such pixels are also detected at other points where red color happens to be present near a high-luminance pixel.

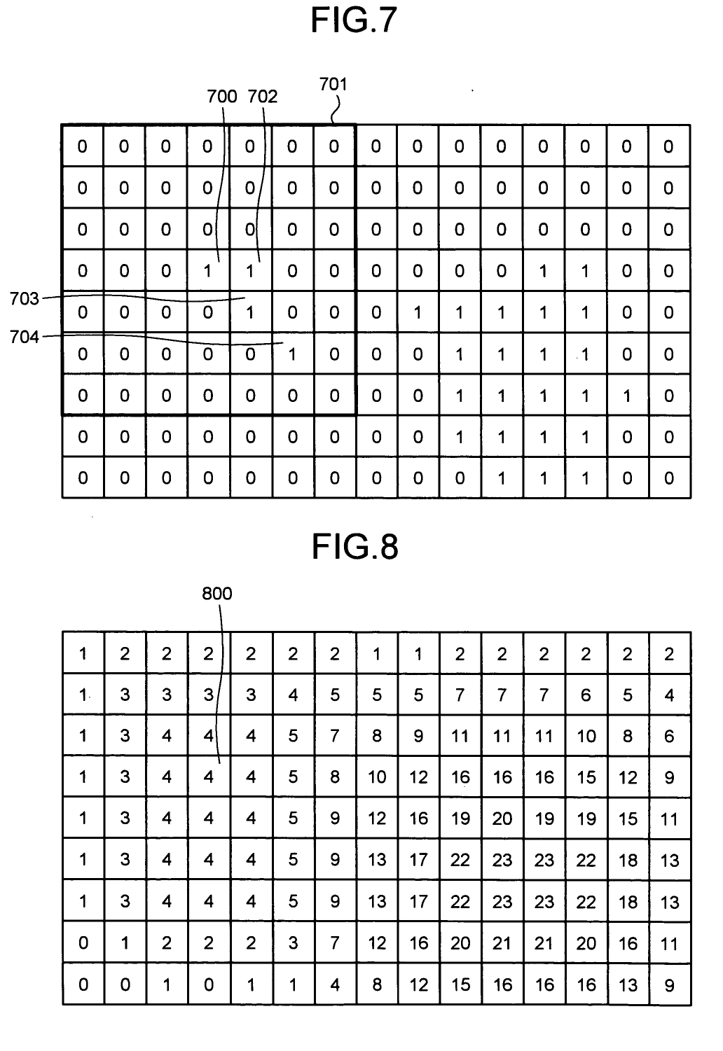

Next, the pointer candidate area specifying unit 201 generate a binary image as shown in FIG. 7, in which the specified pointer candidate pixels are taken as black pixels while others as white pixels (step S602). Then, from the binary image of FIG. 7, a count image as shown in FIG. 8 is generated (step S603).

The value of each pixel in this count image represents a total number of black pixels within a predetermined distance away from the corresponding pixel in the binary image, for example, within three pixels right, left, up, down from the corresponding pixel. For example, as for a pixel 700 in FIG. 7, a range 701 within three pixels from the pixel 700 contains four black pixels including the pixel 700 itself and the pixels 702, 703, and 704. Therefore, in FIG. 8, a pixel 800 corresponding to the pixel 700 of FIG. 7 has a value of “4”. Similarly, for each pixel in FIG. 7, the number of black pixels located near is counted, thereby generating the count image as shown in FIG. 8.

As evident from the above description, in this count image, the pixel has a larger value as more pointer candidate pixels are concentrated. Therefore, for example, the maximum pixel value in the count image is found and is then taken as a threshold (step S604). Then, pixels having values equal to or larger than that threshold are taken as black pixels while others taken as white pixels to generate a binary image (step S605). This allows a portion on which the pointer candidate pixels are concentrated to be extracted from the frame image. Then, the binary image is subjected to labeling to specify rectangles circumscribing a plurality of areas formed by connecting black pixels together, that is, the pointer candidate areas (step S606).

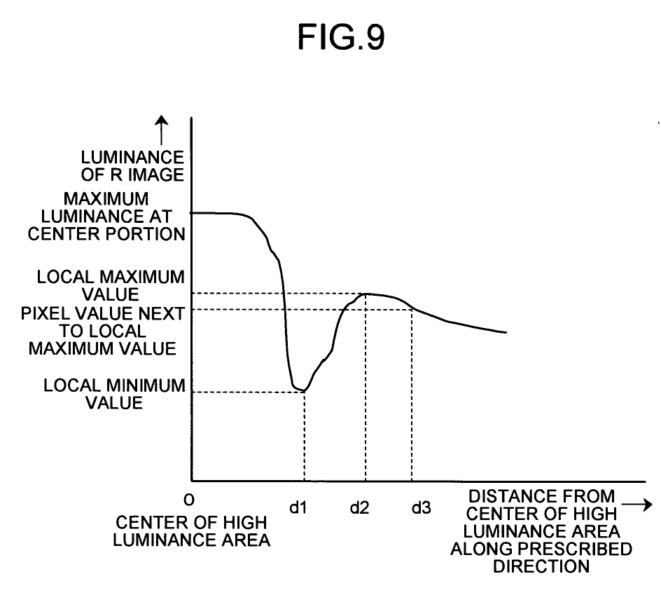

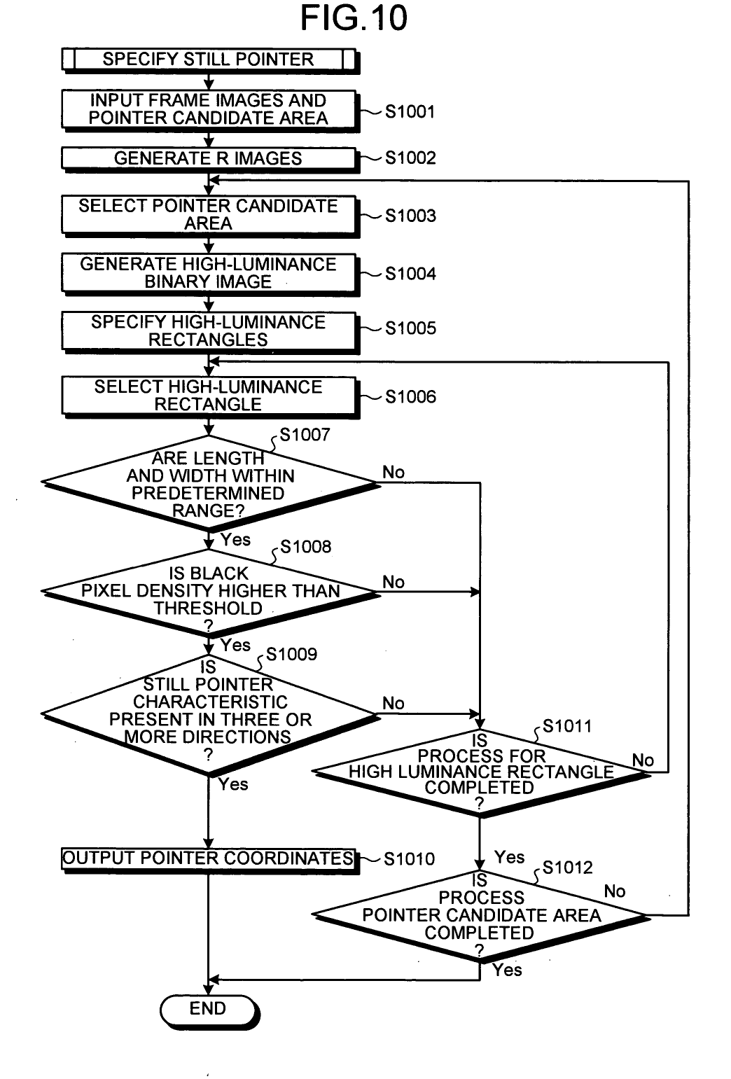

Returning to description of FIG. 2, the still pointer specifying unit 202 is a functional unit of specifying a position of the laser pointer, particularly, the laser pointer completely standing still, in the frame images supplied by the frame image input unit 200. More specifically, of the frame images, a point having a still pointer characteristic as shown FIG. 9 is specified.

FIG. 9 is a graph for explaining a standard distribution of pixel luminance (still pointer characteristic) near a standing-still laser pointer. As shown, the still laser pointer has a characteristic such that its luminance is at the maximum at the center portion of the laser pointer, is decreased at a pixel located a distance d1 away from the center, and is then increased at a pixel located a distance d2 away from the center. Halation occurs at the center of the pointer viewed through the human eye, thereby causing the red color of the laser to be lost and causing a red color to appear in an annular shape near the place located the distance d2 away from the center. Note that the temporary decrease in the luminance at the distance d1 is thought to be due to the characteristic of the camera (CCD), and this decrease cannot be perceived by the human eye.

FIG. 10 is a flowchart of a still pointer specifying process (step S303 of FIG. 3) performed by the still pointer specifying unit 202.

When the frame images are supplied by the frame image input unit 200 and (the coordinates of) the pointer candidate areas in the frame images are supplied by the pointer candidate area specifying unit 201 (step S1001), the still pointer specifying unit 202 generates an R image (a gray-scale image formed by extracting only red components from each image) for each of the images (step S1002).

Next, attention is focused on one of the pointer candidate areas of the R images (step S1003). Then, a high-luminance binary image is generated such that, within a range obtained by externally enlarging the area by a predetermined distance (20 pixels, for example), high-luminance pixels satisfying the R value≧254 are black while the other pixels are white (step S1004). This binary image is then subjected to labeling to specify rectangles each circumscribing an area where a plurality of black pixels are connected together (a high-luminance rectangle) (step S1005).

Next, attention is focused on one of these high-luminance rectangles (step S1006). Then, it is checked whether the length and the width of the rectangle are within a predetermined range (for example, the length and the width are both larger than three pixels and smaller than eleven pixels) (step S1007). Also, it is checked whether the black pixel density in the rectangle is higher than a predetermined threshold (step S1008). These processes are performed to remove a rectangle whose size or degree of concentration of high-luminance pixels are not natural for the still pointer.

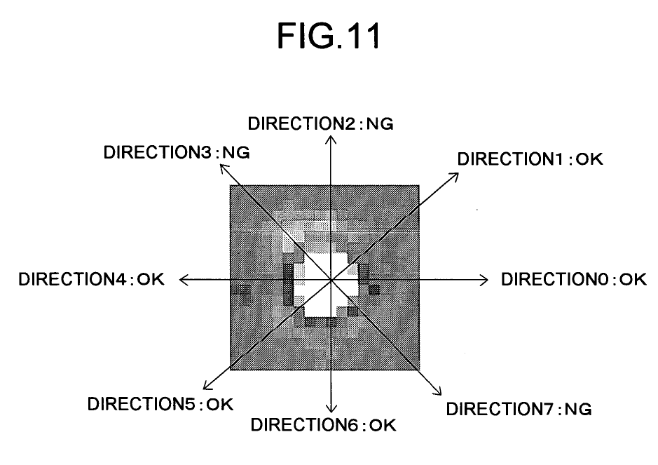

If the rectangle satisfies the above conditions (step S1007: Yes, step S1008: Yes), it is checked whether the rectangle has the still pointer character. As described above, the still pointer has a luminance distribution radially extending from the center point in a manner as shown in FIG. 9. Therefore, as for eight directions as shown in FIG. 11, it is checked to see whether a maximum luminance value (Max), a local minimum value (LocalMin), a local maximum value after the local minimum value (LocalMax), and a pixel value next to the local maximum value (NextLocalMax) satisfy the following relation within a section a predetermined distance (ten pixels, for example) away from the center point of the rectangle:
LocalMin+25≦LocalMax<Max and
   LocalMin≦NextLocalMax<LocalMax.

Then, of these eight directions, if at least three directions satisfy the above relation (step S1009: Yes), the rectangle is determined as a pointer area. Then, the coordinates of the center point is output to the pointer position specifying unit 205, which will be described further below, as the pointer coordinates (step S1010). FIG. 11 depicts the case where the still pointer characteristic can be observed in five out of eight directions.

In this way, in the present embodiment, once a high-luminance rectangle in a pointer candidate area is determined as a pointer area, the remaining high-luminance rectangles and pointer candidate areas are disregarded and the process ends at that moment. Alternatively, all high-luminance rectangles and pointer candidate areas may be checked, and one of the pointer candidate areas may be selected under prescribed criteria. Also, here, the condition is that the luminance distribution that is characteristic to the still pointer is observed in three or more out of eight directions. In essence, the number or the angle of directions may be any as long as it is checked how many directions are present in which the luminance distribution as shown in FIG. 9 can be observed from the center of the place on which high-luminance pixels are concentrated.

If the length and width of the high-luminance rectangle and the black pixel density do not satisfy the above conditions (step S1007: No, step S1008: No) or if the still pointer characteristic is observed in only two, at the maximum, of eight directions (step S1009: No), the above processes are repeated for another high-luminance rectangle, if any, that is unprocessed in the same pointer candidate area (step S1011: No, steps S1006 through S1009).

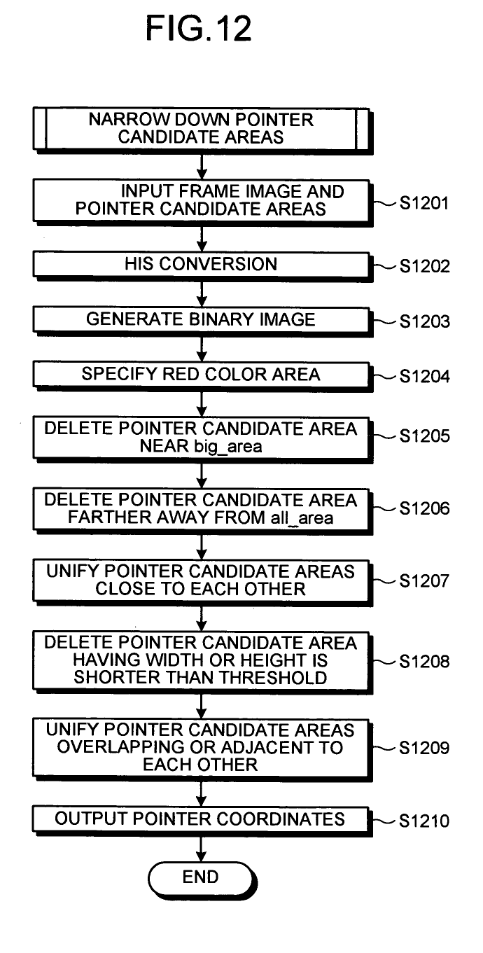

If the above processes performed on all rectangles and yet another unprocessed pointer candidate area is present, attention is focused on the next pointer candidate area to repeat the above processes (step S1011: Yes, step S1012: No, steps S1003 through S1011). If checking of all pointer candidate areas is completed while no still pointer is detected (step S1012: Yes), the procedure goes to the process of FIG. 12, which will be described further below.

Returning to description of FIG. 2, the pointer candidate area narrowing down unit 203 is a functional unit of, if the pointer coordinates cannot be specified in the procedure of FIG. 10, narrowing down the pointer candidate areas supplied by the pointer candidate area specifying unit 201 to possible correct areas as the pointer areas.

As described above, each pointer candidate area specified by the pointer candidate area specifying unit 201 is an area near which high-luminance pixels having the pointer red color are distributed in a concentrated manner. If a slide in the frame image originally includes a red character or picture, a collection of high-luminance pixels which happen to be near there tends to be erroneously determined as pointer candidate areas. To avoid such error, the pointer candidate area narrowing down unit 203 excludes pointer candidate areas which are possibly considered as noises in view of the positional relation between the pointer candidate areas specified by the pointer candidate area specifying unit 201 and the red areas in the frame images.

FIG. 12 is a flowchart of a process of narrowing down the pointer candidate areas (step S305 of FIG. 3) performed by the pointer candidate area narrowing down unit 203.

After the pointer detection process in the procedure of FIG. 10 fails, the frame image input unit 200 and the pointer candidate area specifying unit 201 notified as such by the still pointer specifying unit 202 input the frame image on which the attention is focused and the pointer candidate areas included in that image to the pointer candidate area narrowing down unit 203 (step S1201).

Upon reception of the image and areas, to specify a red color portion in the frame image, the pointer candidate area narrowing down unit 203 first performs an HIS conversion on the image to break down to a hue, a saturation, and an intensity (step S1202). Next, a binary image is generated in which pixels having a hue in a predetermined range (specifically, 210<H≦255 or 0≦H<20), an intensity in a predetermined range (specifically, 80<lum<200), and a saturation equal to or higher than a threshold (specifically, 30) are black and the other pixels are white. That is, a binary image in which only a red color potion in the frame image is black is generated (step S1203).

This binary image is then subjected to labeling to specify rectangles (red color areas) each circumscribing an area formed by connecting black pixels together (step S1204). Note that, hereinafter, all of these rectangles are collectively referred to as “all_area” and the rectangles whose width or height is equal to or longer than a threshold (specifically, 30 pixels) are as “big_area”.

Next, of the pointer candidate areas supplied by the pointer candidate area specifying unit 201, an area within a predetermined distance away from any one of the rectangles of “big_area” is deleted as noise (step S1205). This is because the pointer candidate area as noise tends to be near a large red pattern in the frame image.

Also, of the pointer candidate areas supplied by the pointer candidate area specifying unit 201, an area a predetermined distance or farther away from any rectangles of “all_area” is deleted as noise (step S1206). This is because the pointer candidate area far distanced away from any red pattern is considered as noise since the correct pointer has to be near a red area.

Then, the remaining pointer candidate areas are subjected to unification and noise removal. That is, of the remaining pointer candidate areas, the areas between which a distance is shorter than a threshold (specifically, one pixel) are first unified as one (step S1207). This is done to remove the influence of interlace scan by the camera that shot the frame images, the influence causing a pointer candidate area to appear in every other line while the pointer is moving (causing the correct pointer area to appear as being separately divided).

Next, of the pointer candidate areas after unification, an area having a width or a height shorter than a threshold (specifically, three pixels) is deleted as noise (step S1208). This is done to remove noise by using a feature that when a frame image is shot so as to include the entire slide within a single screen, the size of the pointer is large.

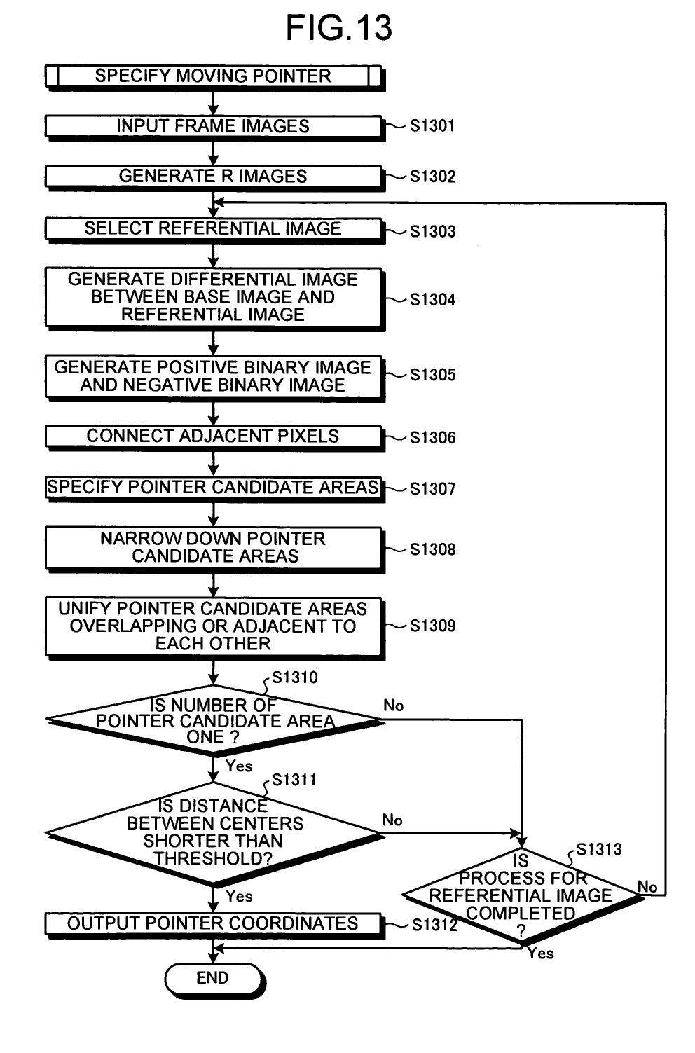

Finally, pointer candidate areas which overlap each other or between which a distance is shorter than a threshold (specifically, ten pixels) are unified together (step S1209). Then, of the pointer candidate areas after unification, the largest area is determined as a pointer area. The coordinates of its center point is then taken as pointer coordinates and is output to the pointer position specifying unit 205, which will be described further below (step S1210). If the number of pointer candidate areas becomes 0 in the course of the above processes, the procedure ends at that moment to go to processes of FIG. 13, which will be described further below.

Returning to description of FIG. 2, the moving pointer specifying unit 204 is a functional unit of performing, when the pointer coordinates cannot be specified with the procedures of FIGS. 10 and 12, a differential process on successive five frames including two images before and after the frame image. This allows the position of the moving laser pointer to be specified.

FIG. 13 is a flowchart of a moving pointer specifying process (step S307 of FIG. 3) performed by the moving pointer specifying unit 204.

After the pointer detection process in the procedure of FIG. 12 fails, the frame image input unit 200 notified as such by the pointer candidate narrowing down unit 203 inputs five frames including the frame image on which attention is focused (hereinafter, “base image”) and two images before and after the base image to the moving pointer specifying unit 204 (step S1301).

Upon reception of these frame images, the moving pointer specifying unit 204 generates an R image for each frame image (step S1302). Next, as a referential image, one of the four frames excluding the base image is selected (step S1303). Here, the order of selecting a referential image is assumed to be “the second frame→the fourth frame→the first frame→the fifth frame”. Therefore, at step S1303 for the first time, the second one, that is, the frame image immediately before the base image, is selected.

Next, a differential image indicative of a difference between the R image of the base image and an R image of the selected referential image is generated (step S1304). This differential image is a gray-scale image having a pixel value in a range of +128 to −127. This differential image is divided by a positive threshold and a negative threshold to generate a positive binary image and a negative binary image (step S1305). That is, from the generated differential image, a positive binary image in which pixels having a value larger than +58 are black and the others are white and a negative binary image in which pixels having a value smaller than −58 are black and the others are white are generated. This process makes it possible to extract portions in which red components are significantly increased in the base image compared with the referential image and portions in which, conversely, red components are significantly decreased therein.

Next, an expansion process is performed on only one pixel in each of the generated binary images to connect the adjacent pixels together (step S1306). This is to remove the influence of interlace, as described above. Next, each of the expanded binary images is subjected to labeling to determine a rectangle circumscribing the area formed by connecting black pixels together. Then, by reducing the coordinates of the rectangle inwardly by one pixel, the pointer candidate areas in the binary images before expansion are specified (step S1307).

Next, in each of the positive binary image and the negative binary image, pointer candidate areas are narrowed down to possible correct areas (step S1308). Specifically, pointer candidate areas whose length and width are in a predetermined range (for example, the width and the height each are longer than two pixels and shorter than 130 pixels) and in which the number of black pixels is larger than a threshold (for example, three) or the black pixel density is larger than a threshold (for example, 0.3) are left, and the other areas are deleted.

Next, in each of the binary images, pointer candidate areas that overlap each other or between which a distance is shorter than a threshold (specifically, five pixels) are unified together (step S1309). At this moment, if the number of pointer candidate areas is one in each of the positive and negative binary images and the distance between the center points of these areas is shorter than a threshold (step S1310: Yes, step S1311: Yes), the coordinates of the center point of the pointer candidate area in the negative binary image are taken as the pointer coordinates for output to the pointer position specifying unit 205 (step S1312).

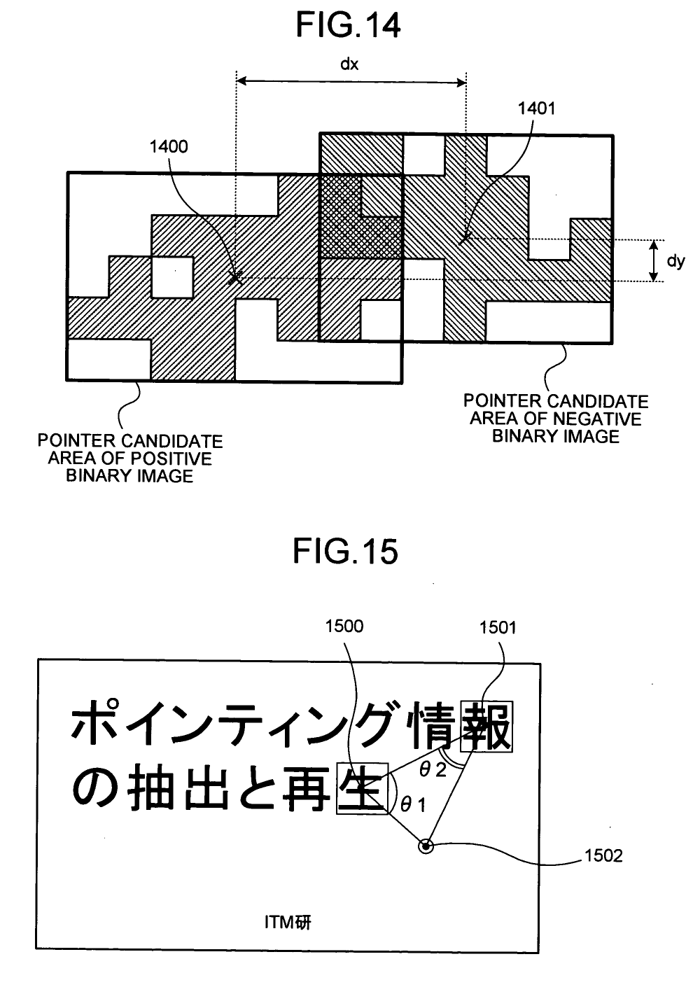

Specifically, as shown in FIG. 14, when a distance dx in the width direction and a distance dy in the height direction between a center point 1400 of the pointer candidate area of the positive binary image and a center point 1401 of that of the negative binary image are both shorter than 20 pixels, the coordinates of the center point 1401 are taken as the pointer coordinates.

Also, if the pointer candidate areas in either one or both of these binary images cannot be narrowed down to one (step S1310: No) or if the positive candidate area and the negative candidate area are far distanced away from each other (step S1311: No), the procedure returns to step S1303 to select the next frame image not yet used as the referential image, if any, from the frame images supplied at step S1301 (step S1313: No). At step S1303 for the second time, the fourth of the five frames in the time series is selected. If checking of all referential images is completed with a pointer not yet being specified (step S1313: Yes), the procedure according to the flowchart ends.

Returning to description of FIG. 2, the pointer position specifying unit 205 is a functional unit of specifying coordinates on a slide being displayed on a frame image that correspond to the pointer coordinates in the frame image supplied by the still pointer specifying unit 202, the pointer candidate area narrowing down unit 203, or the moving pointer specifying unit 204. In other words, the coordinates of a point on the frame images is converted to coordinates originally on the slide.

In conversion by the pointer position specifying unit 205, it is assumed that the frame images and the slides included in the frame image have a one-to-one correspondence. It is also assumed that characters included in each frame image and those included in the corresponding slide have a one-to-one correspondence. The procedure for associating in a one-to-one correspondence will be described further below. In such a correspondence being set, the coordinates originally on the slide can be deduced from the relative position of the pointer coordinates with respect to arbitrary two characters in the frame image.

That is, as shown in FIG. 15, if center points 1500 and 1501 of rectangles circumscribing arbitrary two characters in the frame image and angles θ1 and θ2 of a triangle having a vertex at pointer coordinates 1502 are known, coordinates of a vertex of a triangle formed by center points of the rectangles circumscribing two characters corresponding to those in each frame image and the angles θ1 and θ2 can be calculated as the pointer position. Here, the selected two characters are the ones nearest the pointer coordinates 1502. Alternatively, a relative position with respect to any two characters in the same frame can be used. Also, in the case of a slide without characters, the pointer position can be calculated from a relative position with respect to elements other than characters, such as pictures or graphics.

Returning to description of FIG. 2, the character information storage unit 206 is a functional unit of retaining character information of each frame (such as a frame number; and the character code, position, and size of a character included in each frame) and character information of the original slide (such as a slide number; and the character code, position, and size of a character included in each slide). The character code of each character in the frame images is specified with a general character recognition technology. Also, the character code of each character in the slide is extracted from, for example, a Powerpoint (PPT) file.

The identification information generating unit 207 is a functional unit of associating each frame image and each slide displayed thereon and also associating each character in each frame image and each character in the corresponding slide. Also, the identification information storage unit 208 is a functional unit of retaining the association results (such as the corresponding frame number and slide number and the corresponding character code and position, hereinafter “identification information”) obtained by the identification information generating unit 207.

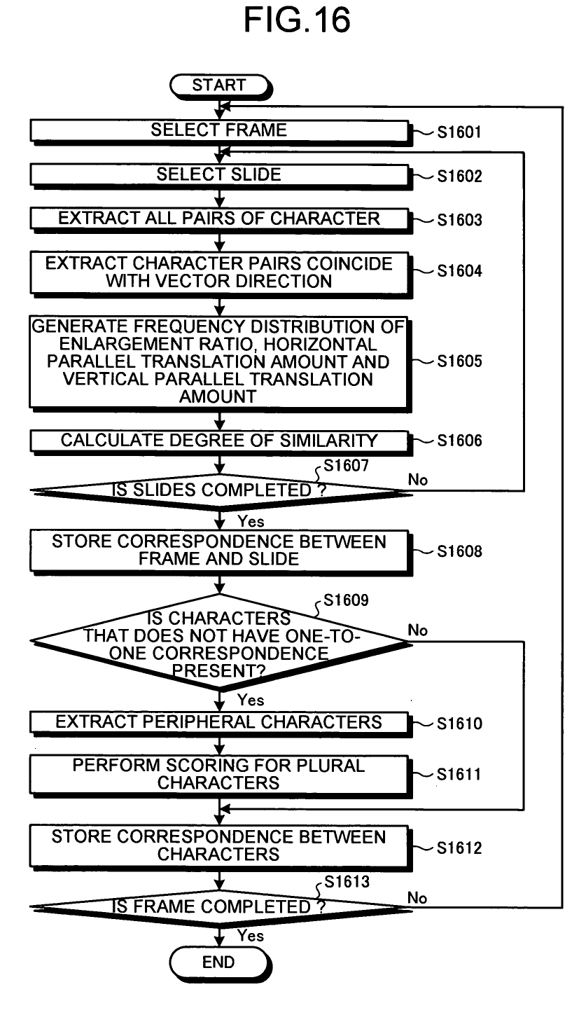

FIG. 16 is a flowchart of an identification information generating process performed by the identification information generating unit 207. This process is broadly divided into (1) a process of associating the frames and the slides, and (2) a process of associating characters included in the frames and the slides associated with each other. In the process (1), the positional relations of all sets of two characters included in both of the frame and the slide are checked. Then, by using the frequency of coincidence between the positional relations, the degree of similarity between the frame and the slide is calculated.

The process (2) is performed so as to narrow down characters not having a one-to-one correspondence with each other, such as a character in a frame corresponding to a plurality of characters in a slide or a character in a slide corresponding to a plurality of characters in a frame, to one corresponding character based on the relative positional relation with the peripheral character. Description is made to these processes in sequence according to the flowchart.

First, a frame and a slide on which attention is to be focused are selected (steps S1601 and S1602). Then, with reference to the character information storage unit 206, all pairs of a character in a frame and a character in a slide having the same character code are extracted (step S1603). Next, from a collection of the extracted pairs, attention is focused on two characters (a1, a2) on the frame and their corresponding two characters (b1, b2) in the slide that form a pair. Then, only pairs in which a direction of a vector between the center points of the two characters on the frame approximately coincides with a direction of a vector between those of the two characters on the slide are extracted (step S1604). In other words, the pairs automatically specified by character code are narrowed down to only pairs assumed to be correct in view of the positional relation with other characters.

Next, for the pairs extracted at step S1604, frequency distributions of an enlargement ratio and horizontal and vertical parallel translation amounts are generated (step S1605). Then, the number of pairs which belong to a range of a predetermined width from the most frequency value in each frequency distribution is regarded as a degree of similarity between the frame and the slide (step S1606). Then, as for the frame on which attention is focused, the degree of similarity with respect to each slide included in a PPT file is calculated (step S1607: No, steps S1602 through S1606). Then, the number assigned to the slide having the maximum degree of similarity is stored in the identification information storage unit 208 in association with the number assigned to the corresponding frame (step S1607: Yes, step S1608).

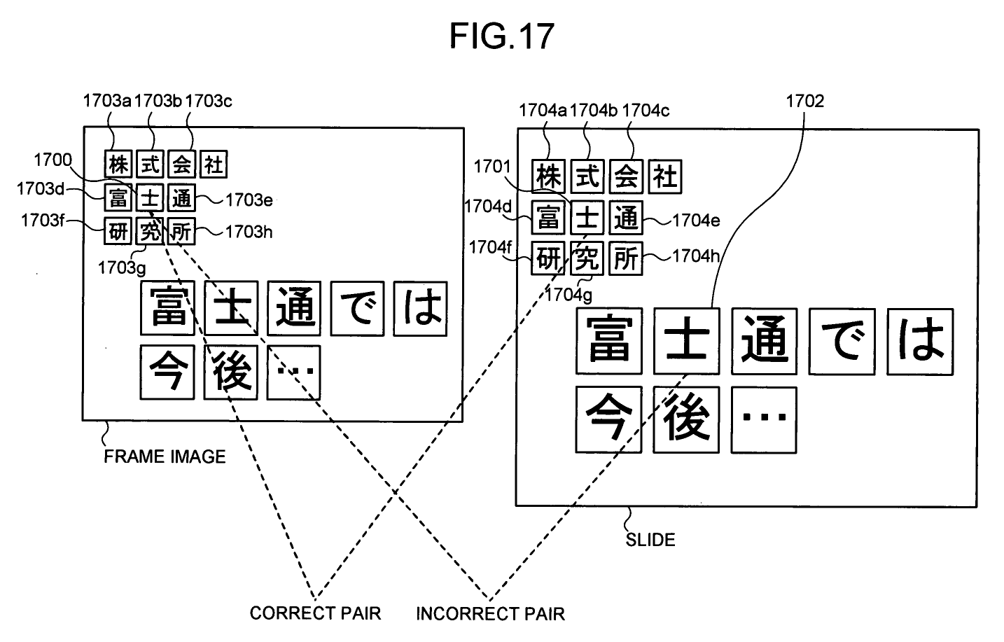

With these processes so far, slide identification mentioned in the process (1) for the frame on which attention is focused is completed. Next, the procedure goes to the process (2) of associating the characters. As described above, the characters in the frame and the slides are temporarily associated with each other based on their character code or the positional relation with other characters. However, these characters do not necessarily have a one-to-one correspondence. In some cases, for example, as shown in FIG. 17, a character 1700 in the frame is associated with a character 1701 as well as a character 1702 in the slide. In such cases, at least either one of the pair of the characters 1700 and 1701 and the pair of the characters 1700 and 1702 is incorrect. Therefore, the identification information generating unit 207 selects only most presumably correct one of the characters 1701 and 1702 associated with the single character 1700.

Here, selection is made based on the positional relation between the character 1701 and the character 1702 with respect to characters 1704a through 1704h that are respectively associated with characters 1703a through 1703h (hereinafter, “peripheral characters”) peripheral to the character 1700. In the case of FIG. 17, the positional relation of the character 1701 to the characters 1704a through 1704h is more similar to the positional relation of the character 1700 to the characters 1703a through 1703h than that of the character 1702 to the characters 1704a through 1704h. Therefore, in this case, the pair of the characters 1700 and 1702 is discarded, and only the pair of the characters 1700 and 1701 is adopted.

If even a single character that does not have a one-to-one correspondence is present in any frame or slide associated at step S1608 (step S1609: Yes), the identification information generating unit 207 extracts its peripheral characters of a character associated with a plurality of characters (step S1601).

A range of characters assumed to be peripheral characters is arbitrary. Here, the range of the peripheral characters is changed according to a standard or average height H of the character in the slide or the frame. That is, as for the character 1700 of FIG. 17, for example, the height H is calculated from the heights of the characters in the frame (the heights of rectangles each circumscribing the relevant character, which are retained in the character information storage unit 206). Then, the characters 1703a through 1703h, which are located n fold of the height H away from the center point of the character 1700, are taken as peripheral characters of the character 1700.

Next, as for the characters 1701 and 1702 associated with the character 1700, scoring is performed in view of the positional relation to the characters 1704a through 1704h corresponding to the peripheral characters 1703a through 1703h, respectively (step S1611). First, as for one of the peripheral characters of the character 1700, the character 1703a, for example, the following two are calculated as indexes for representing the positional relation between these characters:
the angle θ of a vector from the center point of the character 1700 to the center point of the character 1703a, and
a ratio R obtained by dividing the length of the vector by the width of the character 1700 or the width of the character 1703a that is larger than the other.

Next, as an index for representing a positional relation between one of the characters associated with the character 1700, for example, the character 1701, and the character 1704a associated with the character 1703a, angles θ′ and R′ are calculated similarly. When a difference between θ and θ and a difference between R and R′ are smaller than thresholds, for example, when
   |θ−θ′|<0.6 and |R−R′|<0.15
   is satisfied, a pair of the character 1703a and the character 1704a is added to a score of the character 1701 as a peripheral character pair supporting the pair of the character 1700 and the character 1701.

Then, similar process is performed on the peripheral characters 1703a through 1703h to calculate a score of the character 1701. Similarly, a score of the character 1702 is calculated. Then, a character having a maximum score (a maximum total number of peripheral character pairs supporting that character) is adopted as a character to be associated with the character 1700 in a one-to-one correspondence. This process is performed on all characters not associated with another character in a one-to-one correspondence. Then, the final results of the one-to-one correspondence between the characters in the frames and those in the slides are stored in the identification information storage unit 208 (step S1612). If all characters have a one-to-one correspondence at the time of identification of the frames and the slides (step S1609; No), steps S1610 and S1611 are omitted, and the correspondence is stored in the identification information storage unit 208 (step S1612).

Then, the above process is performed on the next unprocessed frame, if any (step S1613: No, steps S1601 through S1612). Upon completion of association of all frame images with slides and association of characters in a one-to-one correspondence (step S1613: Yes), the process according to the flowchart ends.

This process allows the correspondence between the frames and the slides and the correspondence between the characters on the identified frames and slides to be stored in the identification information storage unit 208. The pointer position specifying unit 205 uses this identification information to convert the pointer position on the frame to a pointer position on the corresponding slide. This identification information and character information therefor are generated until step S309 of FIG. 3. Therefore, these pieces of information may be generated in parallel to pointer detection after input of the frame images at step S301, or may be generated in advance before start of the process of FIG. 3.

In the first embodiment, as shown in FIG. 3, places assumed to include a pointer position are first searched for a still pointer and, if not found, these places are narrowed down. If no place can be specified, then a moving pointer is searched for, thereby narrowing down to a pointer position. In actual moving images, however, it is relatively rare that the laser pointer is completely standing still (even if it looks like standing still, a subtle movement by hand is actually present). Also, the scheme of step S307 achieves less omission than the schemes of steps S303 and S305. For this reason, exceptional areas are first extracted, and then the remaining areas are exhaustively searched for detecting a pointer.

The order of these processes is not restricted to the above. According to an experiment performed by the inventors, the degree of accuracy achieved by the schemes of steps S303 and S305 was not so high. In some cases, no pointer could not be found, and worse still, an incorrect position was found as having a pointer located thereat. In this case, the corresponding position on the slide is calculated with the detection error left uncorrected (step S304: Yes or step S306: Yes), thereby degrading the reliability of the automatic process according to the present invention.

To get around this problem, according to a second embodiment described below, the scheme of step S307 is first applied, for example. If no pointer is found, then the schemes of steps S303 and S305 may be additionally performed.

A pointer position specifying device according to the second embodiment has a hardware structure and a functional structure identical to those of the device according to the first embodiment shown in FIGS. 1 and 2. Therefore, description to these structures is omitted herein.

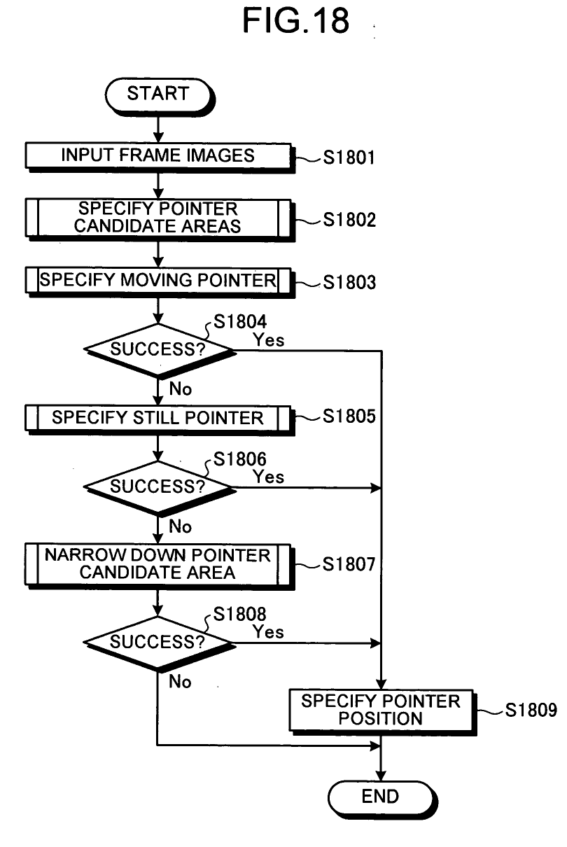

FIG. 18 is a schematic flowchart of a pointer position specifying process performed by the pointer position specifying device according to the second embodiment. This process is different from that according to the first embodiment shown in FIG. 3 only in the order of application of three pointer detecting schemes. That is, the order of FIG. 3 is the scheme of specifying a still pointer (step S303), the scheme of narrowing down pointer candidate areas (step S305), and then the scheme of specifying a moving pointer (step S307), while the order of FIG. 18 is a scheme of specifying a moving pointer (step S1803), a scheme of specifying a still pointer (step S1805), and then a scheme of narrowing down pointer candidate areas (step S1807).

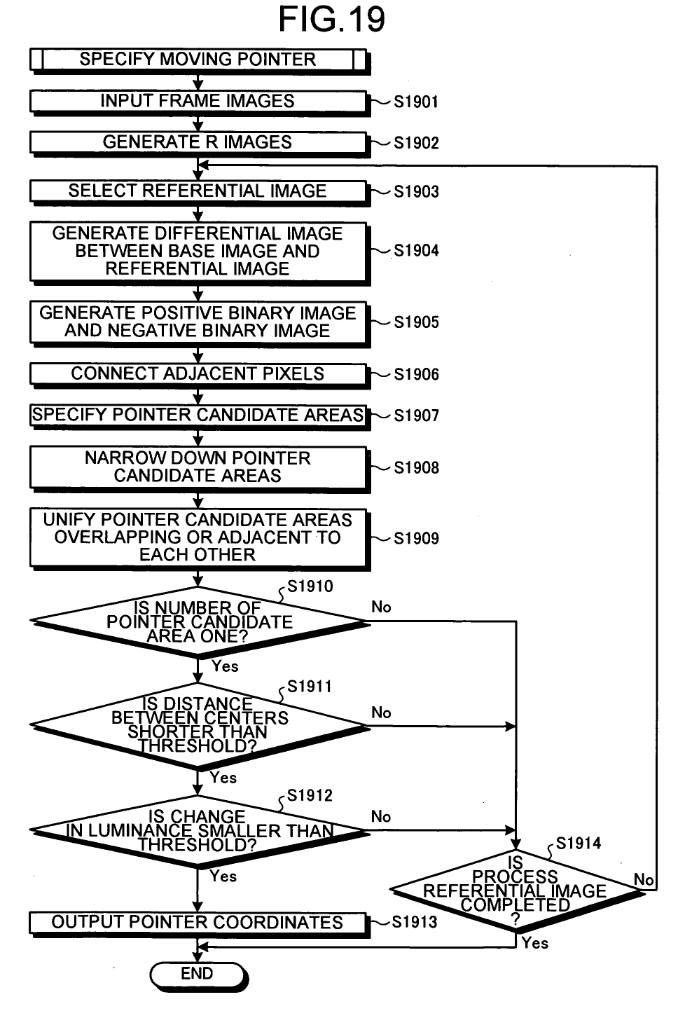

The details on these three schemes may be identical to those according to the first embodiment shown in FIGS. 10, 12, and 13. Here, however, the process of specifying a moving pointer is replaced by the process (step S1803) shown in FIG. 19. The depicted process is a process achieved by improving the process of specifying a moving pointer according to the first embodiment shown in FIG. 13 in four points described below. In the following, description is made mainly to the differences from FIG. 13.

(1) The Range of Referential Images to be Used (Step S1903)

Six frames are used as referential images, which are composed of a frame eight frames before the base image, a frame four frames therebefore, a frame one frame therebefore, a frame one frame thereafter, a frame four frames thereafter, and a frame eight frames thereafter. By extracting these referential images varied in frame interval near the base image, various moving speeds of the pointer can be supported.

(2) Binarization Thresholds for Generating Positive and Negative Binary Images (Step S1905)

To allow a pointer to be extracted even from a bright background of the differential image, the binarization thresholds applied to the differential images to be generated at step S1904 are varied for each pixel. Specifically, if the corresponding pixel value in the base image>196, the binarization threshold for generating a positive binary image is set as 40, and otherwise it is set as 58. Similarly, if the corresponding pixel value in the base image>196, the binarization threshold for generating a negative binary image is set as −40, and otherwise it is set as −58.

(3) Thresholds of the Distance Between Positive and Negative Pointer Candidate Areas (Step S1911)

In determining a distance between the center point of the pointer candidate area left in the positive binary image and the center point of the pointer candidate area left in the negative binary image, when the referential image on which attention is focused on is a frame immediately before or after the base image, the threshold is set as 25. Also, when the above referential image is a frame four frames before or after the base image, the threshold is set as 35. Furthermore, when the referential image on which attention is focused is a frame eight frames before or after the base image, the threshold is set as 45. The reason for setting such thresholds is as follows. When a referential image far distanced away from the base image is used, a distance traveled by the pointer between the frames is extended by that distance, in some cases. In such cases, compared with a referential image near the base image, the threshold for use in determining the presence of the pointer has to be loosened.

(4) Addition of Condition as to Luminance as Well as Distance Between Areas (Step S1912)

In determining one pointer candidate area left in the positive binary image and one pointer candidate area left in the negative binary image as pointer areas, limitations are added, including the distance between the center points as well as changed in luminance. If the remaining candidate areas are correct, the areas corresponding to the referential images and the base image are supposed to have the same pointer image. Therefore, the difference in luminance can be considered as being not so large. Thus, an area corresponding to the pointer candidate area left in the positive binary image is found in (the R images) of the referential images. Then, a maximum value (maximum luminance) of a pixel in the found image is calculated.

Next, an area corresponding to the pointer candidate area left in the negative binary image is found in (the R image) of the base image. Then, a maximum value (maximum luminance) of a pixel in the found image is calculated. Then, if the absolute value of a difference between the maximum values is smaller than a threshold (25, for example), the coordinates of the center point of the pointer candidate area in the negative binary image is taken as the pointer coordinates (step S1912: Yes, step S1913).

According to the above-explained first and second embodiments, the slide and even the point where the lecturer is pointing at can be accurately specified in the shot moving images representing a lecture or the like. Therefore, contents in which moving image playback and enlarged slide display are synchronized with each other can be created in a short period of time and at low cost. Furthermore, no special hardware is required to achieve the above. Still further, no limitations are imposed, such as a prohibition of moving the camera after calibration.

According to an experiment performed by the inventors, of 516 frames in eleven types of videos, a successful ratio in the process of specifying the pointer coordinates on the frame according to the first embodiment is 97.9%. Also, a successful ratio in the improved process of specifying the moving pointer is 99.6%.

In the above first and second embodiments, three types of pointer detecting schemes are combined. As described above, the order of these schemes is arbitrary. Also, these three schemes do not necessarily have to be used in combination.

Furthermore, in the above first and second embodiments, it is assumed as a matter of course that the laser pointer is in red color. If a green laser pointer is used, a pointer green color definition is provided in place of the pointer red color definition. In this case, G images are to be processed in place of the R images (step S1002 of FIG. 10, step S1302 of FIG. 13, and step S1902 of FIG. 19). In this way, the present invention can be applied to the case only with a slight modification. Furthermore, the light source of the pointer is not restricted to be a laser.

In the above first and second embodiments, the correspondence between characters in the identified frames and slides is eventually uniquely determined in consideration of the positional relation with character code as well as other characters. Alternatively, other scheme can be adopted. For example, a pair of one character in the frame and one character in the slide is first generated simply with character code. Then, a parameter for projective transformation is calculated to cause a frame to be projected onto the slide, thereby associating overlapping characters with each other in a one-to-one correspondence.

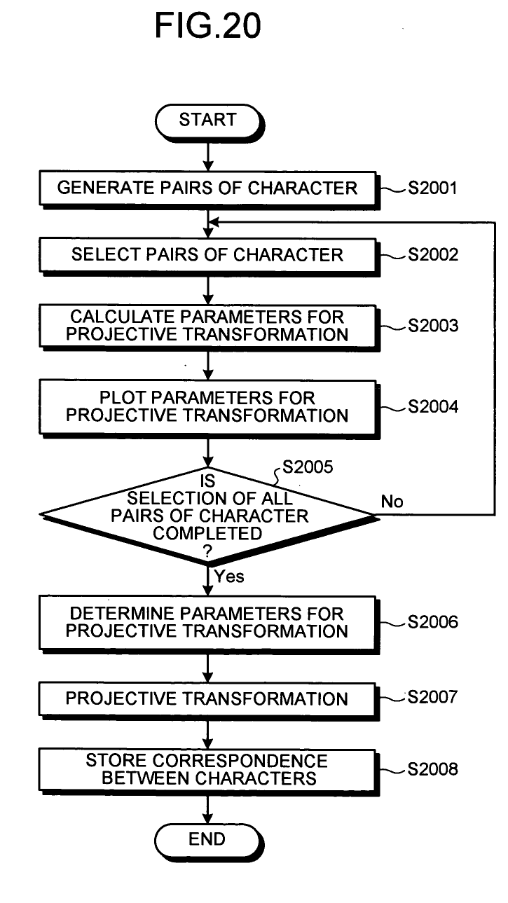

FIG. 20 is a flowchart of a process of associating characters with each other through projective transformation. This process is performed in place of steps S1609 through S1612 after association of the frames and the slides is completed at step S1608 of FIG. 16. First, the identification information generating unit 207 refers to the character information stored in the character information storage unit 206 to generate pairs of a frame character and a slide character that are identical in character code (step S2001), and then one of these pairs is selected (step S2002).

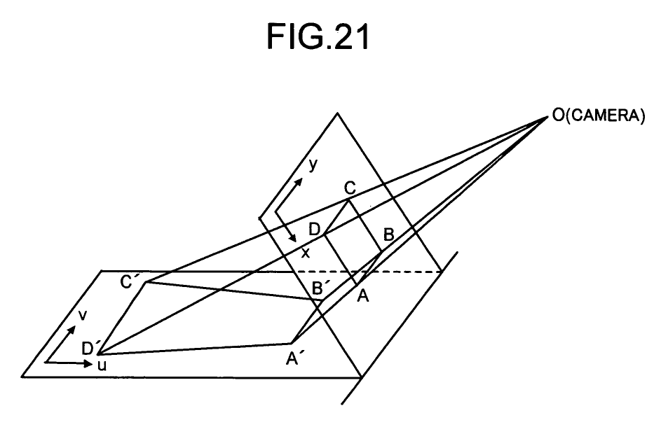

Here, in projective transformation schematically shown in FIG. 21, when a rectangle defined by A-B-C-D is a rectangle circumscribing a frame character in the pair and a rectangle defined by A′-B′-C′-D′ are a rectangle circumscribing a slide character, one point (u,v) on the slide corresponding to one point (x,y) on the frame is represented by the following equations.
u=(ax+by +c)/(gx+hy+1)
v=(dx+ex+f)/(gx+hy+1)

Since four vertexes of one rectangle correspond to those of the other rectangle, parameters of a through h can be calculated by solving simultaneous equations by substitution of coordinates of each vertex (step S2003). These values are then plotted in an eight-dimensional parameter space (step S2004). Calculation of parameters and plotting in a parameter space are then repeated as long as an unprocessed pair is present (step S2005: No, steps S2002 through S2004). Upon completion of the process on all pairs identical in character code (step S2005: Yes), the points having the maximum frequency in the space are determined as correct parameters for projective transformation (step S2006).

By using the above parameters, each character in the frame is then projected on the slide (step S2007). It is then determined that the frame character and the slide character that overlap each other under predetermined conditions correspond with each other, and the correspondence is then stored in the identification information storage unit 208 (step S2008). As described above, the character code of the frame character is specified by character recognition, and erroneous recognition may occur. Therefore, if the degree of reliability in recognition results is lower than a predetermined value, an adjustment may be made such that even characters overlapping each other are not associated with each other.

The pointer position specifying method described in the first and second embodiments can be achieved by causing a program provided in advance to be executed by a computer, such as a personal computer or a work station. This program is recorded on a computer-readable recording medium, such as the hard disk 105, the flexible disk 107, a CD-ROM, a MO, or a DVD, and is read from the recording medium by the computer for execution. Also, the program may be a transmission medium that can be distributed through a network, such as the Internet.

According to the method, the device, and the computer program and method of the present invention, the position where the laser pointer in the moving images is located in the slide displayed therein can be accurately specified without requiring dedicated hardware or the like.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer program for specifying pointer position by identifying coordinates of a pointer on a slide based on an image of the slide and an image of the pointer on the slide, the computer program causing a computer to execute:
generating a differential image between a first image and a second image;
generating two different binary images from the differential image;
identifying areas in which the pointer is possibly located in each of the binary images; and
specifying, when each of the binary images includes one area obtained by unifying the areas identified and a distance between the areas included in the binary images is shorter than a threshold, coordinates of a point on the slide corresponding to either one of center points of the areas included in the binary images.

2. The computer program according to claim 1, wherein the generating two different binary images includes binarizing the differential image with a positive threshold and a negative threshold to generate the binary images of a positive binary image and a negative binary image.

3. The computer program according to claim 2, wherein the generating two different binary images includes binarizing the differential image by using a threshold that is varied with a value of a pixel included in the first image corresponding to a value of a pixel of the differential image.

4. The computer program according to claim 1, wherein the specifying includes specifying the coordinates of the point on the slide corresponding to either one of the center points of the areas included in the binary images when
each of the binary images includes one area obtained by unifying the areas identified,
a distance in the binary images between the areas is shorter than the threshold, and
a difference in luminance between areas in the first and the second images corresponding to the areas included in the binary images is shorter than a threshold.

5. The computer program according to claim 1, wherein the specifying includes identifying the coordinates of the point on the slide corresponding to the center point based on a positional relation of the center point with a plurality of characters in the first image.

6. The computer program according to claim 1, further making the computer execute:
first associating each character in the image with each character in the slide;
calculating, when each character in the image cannot be associated with each character in the slide, a score of a plurality of characters associated with a specific character; and
second associating a character with a maximum score with the specific character.

7. The computer program according to claim 6, wherein the calculating includes calculating the score of the characters based on a positional relation with the characters associated at the first associating with characters located near the specific character.

8. A computer program for specifying pointer position by identifying coordinates of a pointer on a slide based on an image of the slide and an image of the pointer on the slide, the computer program causing a computer to execute:
identifying areas in which the pointer is possibly located in the images;
determining whether a luminance distribution characteristic of the pointer that stands still is present within a predetermined range from a center point of any one of the areas identified; and
specifying, when it is determined at the determining that the luminance distribution is present within the predetermined range, coordinates of a point on the slide corresponding to the center point.

9. The computer program according to claim 8, wherein the determining includes determining whether the luminance distribution is present in a plurality of directions from the center point and, when it is determined that the luminance distribution is present within some of the directions, includes determining that the luminance distribution is present in the predetermined range.

10. The computer program according to claim 8, wherein the identifying includes identified areas on which pixels near which pixels having the specific color are concentrated as areas in which the pointer is possibly located.

11. The computer program according to claim 10, wherein
the specific color is a color that is substantially same as a color of the pointer.

12. The computer program according to claim 8, wherein the specifying includes identifying the coordinates of the point on the slide corresponding to the center point based on a positional relation of the center point with a plurality of characters in the first image.

13. The computer program according to claim 8, further making the computer execute:
first associating each character in the image with each character in the slide;
calculating, when each character in the image cannot be associated with each character in the slide, a score of a plurality of characters associated with a specific character; and
second associating a character with a maximum score with the specific character.

14. The computer program according to claim 13, wherein the calculating includes calculating the score of the characters based on a positional relation with the characters associated at the first associating with characters located near the specific character.

15. A computer program for specifying pointer position by specifying coordinates of a pointer on a slide based on an image of the slide and an image of the pointer on the slide, the computer program causing a computer to execute:
identifying areas in which the pointer is possibly located in the image;
identifying areas of a specific color in the shot image;
narrowing down the areas identified to areas in which the pointer is possibly located based on a positional relation with the area identified; and
specifying coordinates of a point on the slide corresponding to a center point of a largest one of areas obtained by unifying the areas narrowed down.

16. The computer program according to claim 15, wherein the identifying includes identified areas on which pixels near which pixels having the specific color are concentrated as areas in which the pointer is possibly located.

17. The computer program according to claim 15, wherein
the specific color is a color that is substantially same as a color of the pointer.

18. The computer program according to claim 15, wherein the specifying includes identifying the coordinates of the point on the slide corresponding to the center point based on a positional relation of the center point with a plurality of characters in the first image.

19. The computer program according to claim 15, further making the computer execute:
first associating each character in the image with each character in the slide;
calculating, when each character in the image cannot be associated with each character in the slide, a score of a plurality of characters associated with a specific character; and
second associating a character with a maximum score with the specific character.

20. The computer program according to claim 19, wherein the calculating includes calculating the score of the characters based on a positional relation with the characters associated at the first associating with characters located near the specific character.

21. A method of specifying pointer position by identifying coordinates of a pointer on a slide based on an image of the slide and an image of the pointer on the slide, comprising:
generating a differential image between a first image and a second image;
generating two different binary images from the differential image;
identifying areas in which the pointer is possibly located in each of the binary images; and
specifying, when each of the binary images includes one area obtained by unifying the areas identified and a distance between the areas included in the binary images is shorter than a threshold, coordinates of a point on the slide corresponding to either one of center points of the areas included in the binary images.

22. The method according to claim 21, wherein the generating two different binary images includes binarizing the differential image with a positive threshold and a negative threshold to generate the binary images of a positive binary image and a negative binary image.

23. The method according to claim 21, wherein the specifying includes identifying the coordinates of the point on the slide corresponding to the center point based on a positional relation of the center point with a plurality of characters in the first image.

24. The method according to claim 21, further comprising:
first associating each character in the image with each character in the slide;
calculating, when each character in the image cannot be associated with each character in the slide, a score of a plurality of characters associated with a specific character; and
second associating a character with a maximum score with the specific character.

25. A device for specifying pointer position by identifying coordinates of a pointer on a slide based on an image of the slide and an image of the pointer on the slide, comprising:
a differential image generating unit that generates a differential image between a first image and a second image;
a binary image generating unit that generates two different binary images from the differential image;
an area identifying unit that identifies areas in which the pointer is possibly located in each of the binary images; and
a pointer position specifying unit that specifies, when each of the binary images includes one area obtained by unifying the areas identified and a distance between the areas included in the binary images is shorter than a threshold, coordinates of a point on the slide corresponding to either one of center points of the areas included in the binary images.

26. The device according to claim 25, wherein the pointer position specifying unit specifies the coordinates of the point on the slide corresponding to the center point based on a positional relation of the center point with a plurality of characters in the first image.
